(19) United States
(12) Patent Application Publication
(10) Pub. No.: US 2014/0048165 A1
(43) Pub. Date: Feb. 20, 2014

(54) Water Transport Line for a Plant Watering System and Plant Watering System

(71) Applicants: Ralf Claus, Illerkirchberg (DE); Thomas Renner, Ulm (DE)

(72) Inventors: Ralf Claus, Illerkirchberg (DE); Thomas Renner, Ulm (DE)

(73) Assignee: HUSQVARNA AB, Huskvarna (SE)

(21) Appl. No.: 14/114,287

(22) PCT Filed: May 19, 2011
(86) PCT No.: PCT/EP2011/058152

§ 371 Date: Oct. 28, 2013

(51) Int. Cl. F16L 11/02

(52) U.S. Cl. CPC F16L 11/02
USPC 138/123

(57) ABSTRACT

The invention relates to a plant watering system, in particular for a drip watering system. According to the invention, said system comprises a water transport line operating according to the capillary effect principle, comprising a fibrous material arranged in a water-tight covering (HU) arranged between a water reservoir (VB) and a plant pot (TO), in particular a pot (TO) filled with a soil substrate (ES). Said fibrous material consists of a non-woven containing a mixture of microfilaments formed from of at least two different plastic materials and has a titer of preferably less than 1.0 dTex. Said fibrous material is preferably in the form of a strip (SB).

The invention relates to a water transport line for a plant watering system and to a plant watering system, in particular according to a type of watering system for a potted plant, as well as a plant watering system of this type.

Watering systems for watering potted plants are known, in which at least one strand made of fibrous material runs as a water transport line between a reservoir and an soil substrate surrounding the plants that are to be watered. Water from the reservoir is transported by means of the capillary effect within the fibrous material at a limited flow rate to the soil substrate via the strand made of fibrous material, particularly, at least in sections, also counter to the effect of gravity. By way of example, wool filaments or other organic fibers serve as the fibrous material, but synthetic fibers have also been used. The strand made of fibrous material can be enclosed in a water-tight hose.

Such water transport lines have been shown to be unsatisfactory with regard to a reliable and uniform watering.

The present invention assumes the objective of providing a water transport line suitable for watering systems according to the type used for a watering system for potted plants comprising a strand made of fibrous material, as well as a watering system having a water transport line of this type.

Solutions according to the invention are described in the independent Claims. The dependent Claims contain advantageous designs and further developments of the invention.

The use of a nonwoven made of synthetic fibers, which are at least substantially, i.e. having more than 50% by weight, and preferably are substantially entirely, made of microfilaments having an average titer (also referred to as the fiber weight), averaged from all of the fibers, of less than 1.0 dTex, and consisting of at least two different materials, has been shown to be surprisingly reliable in comparison with the fibrous materials conventionally used for capillary watering for the watering of a soil substrate in a plant pot. Preferably, the average titer of the fibers of the nonwoven is less than 0.6 dTex, and in particular is less than 0.3 dTex.

Nonwovens of this type are known per se, e.g. from DE 69725051 T2 or DE 10026281 B4. The production of the nonwoven typically occurs by means of spinning the fibers, which exhibit numerous partial areas of at least two different synthetics in the cross-section, and through unraveling of the fibers into microfilaments having a homogenous substance by means of thermal or, particularly, mechanical effects.

In an advantageous further development, the water transport line can contain algicide substances, which inhibits algae growth in the water transport line. The algicide substance can, advantageously, be integrated in the nonwoven in the form of metal filaments, particularly of copper or silver, or of filaments coated with these substances.

The water transport line is advantageously implemented as a flat strip, at least over the course of most of its length. Advantageously, the fibrous material is enclosed over more than 50% of the length of the water transport line by a water-tight cover, in particular, a hose. Advantageously, the nonwoven lies against the inner surface of the casing, subject to an elastic deformation of the casing or the fibrous material. At the opposite ends of the transport line, the nonwoven is not enclosed, in order to be able to absorb water from the water reservoir, and to release said water onto the plants that are to be watered.

The invention shall be explained in greater detail in the following, based on preferred embodiment examples with reference to the drawings. They show:

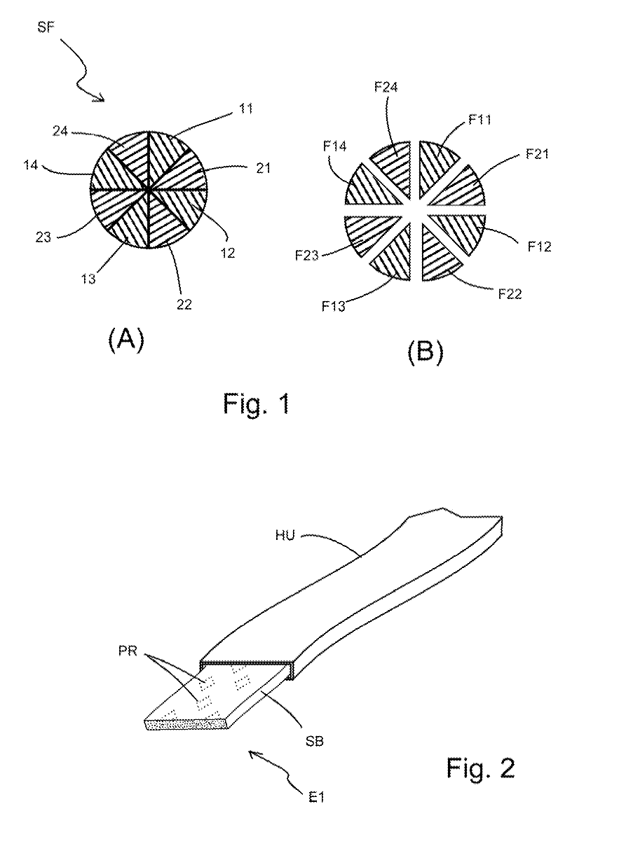

FIG. 1 filament cross-sections

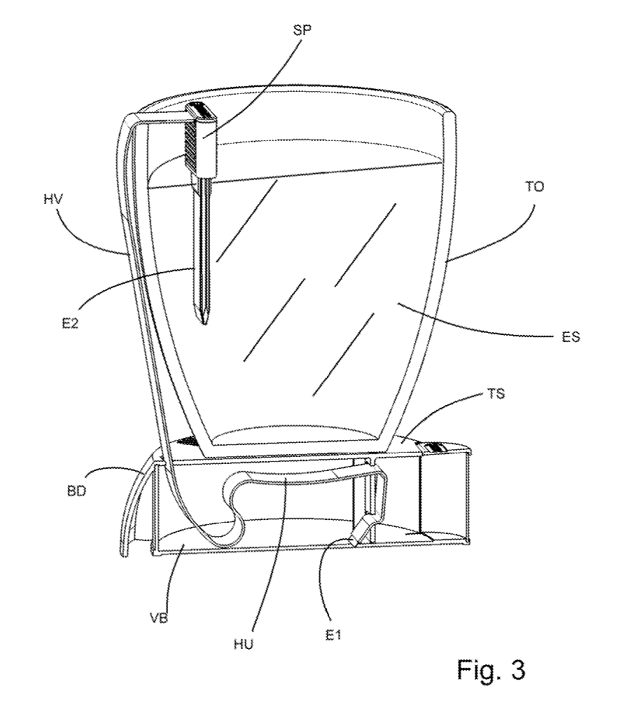

FIG. 2 a line section

FIG. 3 a watering system

FIG. 1 shows two fiber cross-sections of synthetic fibers known per se, of the type described above from the previously specified prior art. For this, fibers of the type indicated in FIG. 1 (A) with the reference symbol SF are spun in a spinning process, wherein said fibers consists of two synthetics that do not mix with one another. The synthetics form sections abutting one another at their boundary surfaces of the cross-section of the fibers SF, which are indicated with the reference symbols 11, 12, 13, 14 for a first synthetic material, and the reference symbols 21, 22, 23, 24 for a second synthetic material, in FIG. 1 (A). The fibers are combined to form a loose composite, and by means of thermal, or in particular, mechanical effects, e.g. high-pressure water jets or steam, the fibers are split into respective microfilaments, having a homogenous material, corresponding to the subareas of the cross-section according to FIG. 1 (A).

The microfilaments resulting from a fiber SF are schematically depicted in FIG. 1 (B), and indicated by the reference symbols F11-F14 and F21-F24. Typically, with the splitting of a loose composite comprised of a plurality of fibers, a bonding and solidification of the various microfilaments among themselves to form a nonwoven composite is obtained at the same time, wherein, typically, the fibers and the individual microfilaments can be regarded as continuous fibers, in which the fraying effect of fibers is essentially negligible. The spatial configuration of the individual microfilaments in a fiber, selected in FIG. 1 (B) for illustrative purposes, is substantially abolished thereby.

A nonwoven produced in this manner, known per se, forms a flat, flexible fabric panel. A strip is cut from this for the use of such a fabric in a plant watering system, which, in a water transport line depicted with an end section in FIG. 2, is encased by a water-tight covering HU over the course of the substantial part of the longitudinal course of the water transport line. The strip SB made of the nonwoven having the microfilaments according to FIG. 1 basically entirely fills the intermediate space formed by the cover HU thereby, particularly in the direction of the short axis of the interior space of the cover HU, i.e. perpendicular to the surface of the flat nonwoven. Advantageously, the nonwoven forming the strip SB can lie against the inner wall of the cover when the cover HU and/or the nonwoven itself is subjected to a slight elastic deformation. The relative dimensions are not to be regarded as being drawn to scale in the depiction in FIG. 2.

Furthermore, it has been shown to be advantageous if there are embossed structures PR in one or both of the opposing surfaces of the strip, rising from the strip surface in the flat strip SB made of the fibrous material of the nonwoven. Embossed structures PR of this type are depicted in FIG. 2 with dotted lines on the strip surface facing the observer.

The section of a water transport line depicted in FIG. 2, in which the nonwoven is incorporated as the fibrous material, can form, in particular, the first end E1 of the water transport line extending into a water reservoir for a plant watering system, as is depicted in the schematic view of a plant watering system in FIG. 3. The plant watering system depicted in FIG. 3 contains, in particular, a water reservoir VB, which is closed at the top by means of a lid BD. An upper surface of the lid BD also forms a supporting surface TS for a plant pot TO, which can contain a soil substrate ES and at least one plant, not shown in FIG. 3. On the second end E2 of the water transport line, facing away from the first end E1, a mechanically more stable stake SP is provided, which can be driven into the soil substrate ES, and at which the fibrous material of the nonwoven without a cover is in contact with the soil substrate ES, in order to release water into the soil substrate ES. The embossed structures PR have also proven to be particularly advantageous for the release of water into the soil substrate.

The strip made of the fibrous nonwoven is enclosed by the water-tight cover HU between the first end E1 and the second end E2, or respectively, the stake SP disposed at the second end E2, such that no water evaporates into the surrounding environment. The transport line can, in particular, transport water in a substantially vertical section HV in opposition to the effect of gravity through the exploitation of the capillary effect in the known manner used in capillary watering. The water transport line is advantageously designed to be flexible from the first end E1 to the stake SP, or up to the vicinity thereof.

The features described above and in the Claims, as well as those that can be derived from the drawings, can be advantageously implemented individually as well as in combinations thereof.

The invention is not limited to the embodiment examples described herein, but can be adapted in numerous ways within the framework of the abilities of persons skilled in the art.

1. A water transport line having fibrous material, suitable for transport of water in a plant watering system, against the effect of gravity, through the exploitation of the capillary effect in the fibrous material, characterized in that the fibrous material is formed from a flexible nonwoven, which is comprised, at least substantially, of microfilaments having an average titer of less than 1.0 dTex, and is comprised of at least two different synthetic materials.

2. The water transport line according to claim 1, characterized in that the average titer of the microfilaments is less than 0.6 dTex.

3. The water transport line according to claim 1, characterized in that the nonwoven is designed in the shape of a strip, at least over most of the length of the water transport line.

4. The water transport line according to claim 1, characterized in that the nonwoven is provided with embossed structures rising from a continuous fabric surface.

5. The water transport line according to claim 1, characterized in that the fibrous material is enclosed in a water-tight cover, at least substantially over the course of the length of the water transport line.

6. The water transport line according to claim 5, characterized in that the fibrous material rests against the cover, subject to an elastic deformation of the cover and/or the fibrous material.

7. The water transport line according to claim 1, characterized in that a dimensionally stable stake is disposed on one end of the water transport line.

8. The water transport line according to claim 1, characterized in that it contains algicide substances.

9. The water transport line according to claim 8, characterized in that the algicide substance is present in the form of metal filaments, particularly made of copper or silver.

10. A plant watering system for watering at least one plant in a plant pot, having a water reservoir and having a water transport line, the water transport line having fibrous material, suitable for the transport of water in the plant water system, against the effect of gravity, through the exploitation of the capillary effect in the fibrous material, characterized in that the fibrous material is formed from a flexible nonwoven, which is comprised, at least substantially, of microfilaments having an average titer of less than 1.0 dTex, and is comprised of at least two different synthetic materials.

11. The plant watering system according to claim 10, characterized in that a lid for the water reservoir is designed as a supporting surface for a plant pot.

12. An application of a nonwoven for a water transport line in a plant watering system, wherein the nonwoven is at least substantially comprised of microfilaments having an average titer of less than 1.0 dTex and comprises of at least two different synthetic materials.

13. The application according to claim 12, characterized in that algicide substances, in particular in the form of metal fibers, are integrated in the nonwoven.

14. The plant watering system according to claim 1, wherein the plant watering system comprises a pot watering system.

15. The plant watering system according to claim 10, wherein the plant watering system comprises a pot watering system.
